(19) United States
(12) Patent Application Publication
(10) Pub. No.: US 2012/0159566 A1
(43) Pub. Date: Jun. 21, 2012

(54) ACCESS CONTROL FRAMEWORK

(75) Inventors: Jan Hrastnik, Grosse Ringstr (DE); Christian Lehmann, Walldorf (DE)

(73) Assignee: SAP AG, Walldorf (DE)

(21) Appl. No.: 12/972,131

(22) Filed: Dec. 17, 2010

(51) Int. Cl. G06F 21/24; G06F 21/00

(52) U.S. Cl. 726/1; 726/21

(57) ABSTRACT

A system and method for flexible access controls access be setting access permissions at the object element or subject level. An access control framework (ACF) may be implemented to control access to business objects, business object nodes, business object queries, actions, attributes, associations, instances, or other identifiable elements. The access control configurations for a user or object may be set at the system level with static configuration settings. In an embodiment, a user may temporarily reconfigure access permissions for a subject or object for a limited session with dynamic configuration settings.

### BACKGROUND

Aspects of the present invention relate generally to the field of information systems and computer software and more specifically to providing access control for business applications.

An access control system provides the ability to control the subjects (who or what) that have access to a given object. A subject must be granted access to an object in order to read or view the object, write to the object, otherwise edit the object, or performing any available action on, with, to, or involving the object. An access control system may restrict access to certain objects by identifying and authenticating individuals or subjects that log on to a system, and associating the individual or subject with the objects that they are able to access or control as a result of logging in, authorizing what an individual or subject can do once they have gained access to the system, and tracking the actions performed on an object by an individual or subject using the system.

Access control systems may restrict access to certain types of objects for different reasons. For example, access to software may be restricted to allow only certain individuals or groups the ability to edit or modify the code, to maintain version control or confidentiality. Access to software executables may be restricted to allow only certain individuals or groups to run a program, for example, to maintain the terms of a license or to maintain confidential information. Access to modules or objects within an application may be restricted to allow only certain individuals or groups access to certain program features, for example to monitor usage or errors in the logs kept by the application, to restrict access to confidential information, or to maintain the terms of a license.

In business information systems, an access control system may restrict access permissions by business objects. A business object is a software model that represents various components of the business. For example, a business object may represent a document such as a sales order, a purchase order, or an invoice. A business object may also represent other more complex components, including a product, a business partner, a customer, or a piece of equipment.

Conventionally, complex business information systems control access to business objects with role based access control. Under role based access control, also known as role based access management, access to objects is controlled at the system level and determined by the role assigned to each subject. Thus an assigned role conveys a set of permissions for each subject. Only subjects having an authorized role may access an object. A group of users may be given the same access permissions by assigning them the same role. However, the access assigned to a role has limited flexibility and subjects in a role based access control system have limited control over which objects they can access.

Further, role based access control may inconveniently restrict access to information and functionalities that may be required for non-traditional purposes. For example, in developing and implementing automated tests within a business information system, it may be necessary to identify previously accessed business objects and their services in order to setup a proper test environment. Additionally, the interactive behaviors between business objects may change during the lifecycle of the business information system. Problems and errors resulting from those changes may be difficult to detect and analyze because related symptoms may not occur regularly. Thus more flexible access to business objects and system information, including logging information, and to certain functionalities within a business information system may be desired.

### BRIEF DESCRIPTION OF THE DRAWINGS

FIG. 1 is a simple block diagram illustrating components of an exemplary system according to an embodiment of the present invention.

FIG. 2 is a functional block diagram illustrating components of an exemplary system according to an embodiment of the present invention.

FIG. 3 illustrates an exemplary method for accessing a system according to an embodiment of the present invention.

FIG. 4 shows an exemplary user interface according to an embodiment of the present invention.

### DETAILED DESCRIPTION

An access control framework (ACF) may be implemented to provide flexible and granular access controls for business objects within a business center application or business information system. The access control configurations for a user or object may be set at the system level with static configuration settings. The access control configurations for a subject or object may be set for a limited session with dynamic configuration settings. An access control configuration may be set at least to permit the user access to business objects, business object nodes, business object queries, actions, attributes, associations, instances, or other identifiable elements. The capability to set access permissions for an object or element may be used to define a test element and service simulations executed in an automated test, to detect changed interaction patterns between objects and detect adaptations to compensate for the change to ensure effective application development, to aid the enforcement of proper access during multi-partner based development, or to monitor or control user access to assist in customer support endeavors or to establish variable or per use billing.

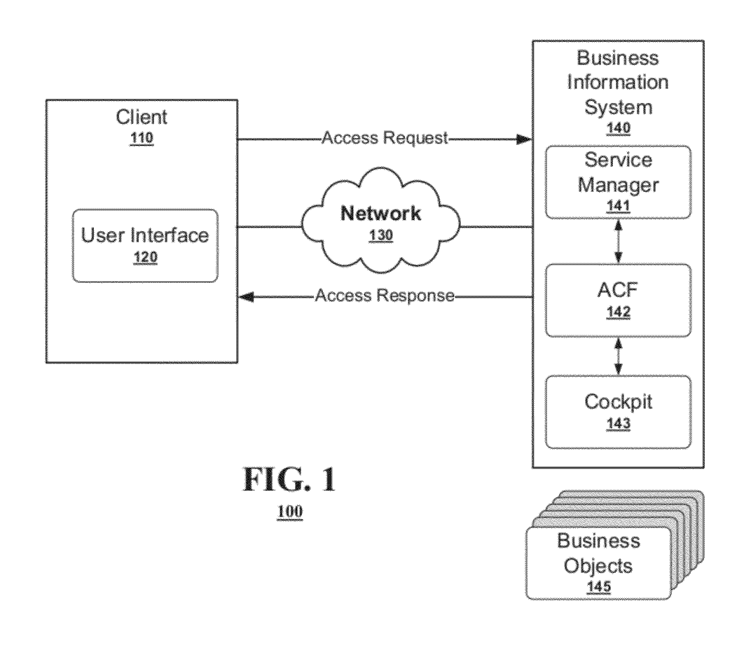

A subject may access the business information system in a client-server environment, or a networked environment. FIG. 1 is a simple block diagram illustrating components of an exemplary system 100 according to an embodiment of the present invention. As shown in FIG. 1, a system 100 may comprise a client 110 having a user interface 120 and a business information system 140 having a service manager 141, an access control framework (ACF) 142, and a cockpit 143. The client 110 may be a server connected to the business information system 140 via a network 130. In an embodiment, in a networked environment, the business information system 140 may be connected to a plurality of clients (not shown) each similar to client 110. The client 110 may be any computing system that facilitates the user accessing the business information system 140, for example a personal computer or mobile handheld computing device.

A user may access business objects or elements 145 stored in the business information system 140 with the client 110 via a user interface 120 capable of accessing the business information system 140 and delivering to the user or otherwise displaying the information retrieved therefrom. The user interface 120 may be a program or application, may comprise middleware, or may run on a computing device accessible to the user, that acts as a frontend to and facilitates access to the business information system 140. The user may interact with the user interface 120 through an input device, such as by inputting a selection as with a mouse or inputting an access request as with a keyboard. The user may observe the response to the access request on an output device or display. In accordance with an aspect of the invention, the user interface 120 may run in a browser window controlled by the user.

A business object 145, as described above, may be a representation of a sales order, a purchase order, an invoice, a product, a business partner, a customer, a piece of equipment, or other real-world business item that may be represented in the business object software model. A plurality of business objects 145 may be stored at the business information system 140 in a local memory, a database for example. Then information about each a business object 145 may be stored in a record for each business object 145, and the record may include permissions for the object or an element of the object. The business object information may then be retrieved by querying the database.

The network 130 connecting the client 110 and the business information system 140 may be a wired or wireless network that may include a local area network (LAN), a wireless area network (WAN), the Internet, or any other network available for accessing the business information system 140 with the client 110. The client 110 may request access to the business objects 145, or an element of a business object via the network connection 130.

The service manager 141 at the business information system 140 may receive the access requests from the client 110. The business information system 140 may be a server or other device connected to the network 130 having a local memory storage and a processor to execute instructions that implement the service manager 141 and the ACF 142. The business information system 140 may respond to the access request with an access response granting or denying access to the requested object or element. A business object 145 for which access is granted may be presented to the user via the user interface 120.

The service manager 141 may invoke the ACF 142 to determine whether access should be granted or denied. The ACF 142 may allow access to an object or element for a session or for a specified user. Direct access to the ACF 142 may be achieved via the cockpit 143. The cockpit 143 is a user interface that may grant a user access to the logs kept by the ACF 142. The cockpit 143 may additionally provide an interface for editing the permissions and other settings of the ACF 142. Providing flexible and granular access to the business objects and elements of the business information system 140 may allow for greater management of access to the business information system 140, of the information stored therein, and of the information developed and collected during run time.

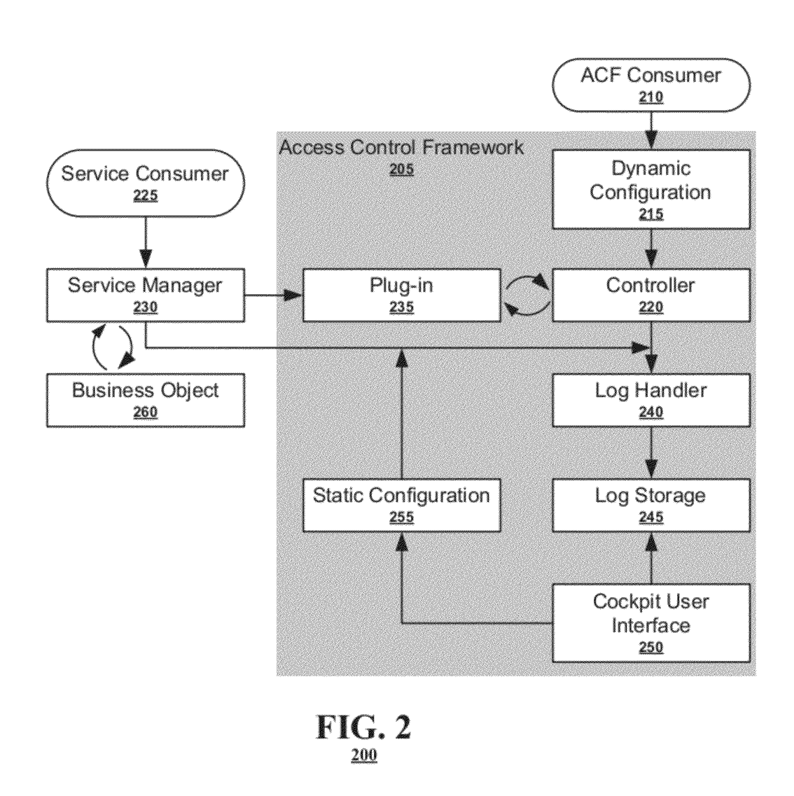

FIG. 2 is a functional block diagram illustrating components of an exemplary system 200 according to an embodiment of the present invention. As shown in FIG. 2, the system 200 may include a service manager 230, a business object 260 and an access control framework (ACF) 205. The ACF 205 may further comprise a plug-in 235, a controller 220, a log handler 240, a memory device for log storage 245, a user interface 250, and stored configuration files for static configuration 255 and dynamic configuration 215. The static configuration 255 may be set at the system level and may persist between sessions. Then, a subject may access the business object 260 in accordance with the system defined access controls, for example, according to the permissions granted according to the subject's role. Static configuration 255 may grant access permissions for business components or elements of varying size including a business object, an attribute, a business object node, a business object query, an action, an association, or an instance. As a further aspect of the static configuration 255, a subject may be granted access to the ACF 205, for example, granting the subject ACF consumer status to access configuration settings and logs.

An ACF consumer 210 (a subject with ACF consumer status) may access the ACF 205 to edit the dynamic configuration 215. An ACF consumer 210 may edit the dynamic configuration 215 to set access controls for a subject or object that may persist for the duration of a session but no longer. For example, the dynamic configuration 215 may be set to allow a subject access to a business object 260. A prerequisite of element access as defined by the ACF 205 may include logging access information about the access request with the log handler 240 in order to develop relevant test data. Or the dynamic configuration 215 may be set to allow a subject to edit an attribute of a business object 260 in order to implement a one-time update to the business object 260. Then, the next time the subject accesses the business information system, the subject may have access permissions as assigned by the static configuration 255, but no longer receive the access as defined in the dynamic configuration 215.

A service consumer 225 may access the ACF 205 as a subject, via the service manager 230. When the ACF 205 is available to the subject, the service manager 230 may invoke the ACF option via a plug-in 235. Upon receiving a request for access to the business object 260 from the service consumer 225, the plug-in 235 may then route the request to the controller 220. The configuration settings 215 and 255, may then be evaluated by the controller 220. If the dynamic configuration 215 is set such that the access request may be granted or if the dynamic configuration 215 is not set to allow the access but the static configuration 210 is set to grant the access request, the requested object or element may be presented to the service consumer 225.

The configuration settings evaluated by the controller 220 may initiate additional logging functionality. If additional logging is initiated, the log handler 240 may collect information from the controller 220 to make an appropriate entry in the log. The compiled log may then be stored in the log storage 245 and may be updated for each access request for which logging is initiated. The log may persist in log storage 245 for the duration of a single session or may be stored for a longer period of time to allow for review and debugging. The log storage 245 may be accessed via the cockpit user interface 250 to display the contents of the log to an ACF customer 210 with access to the ACF 210.

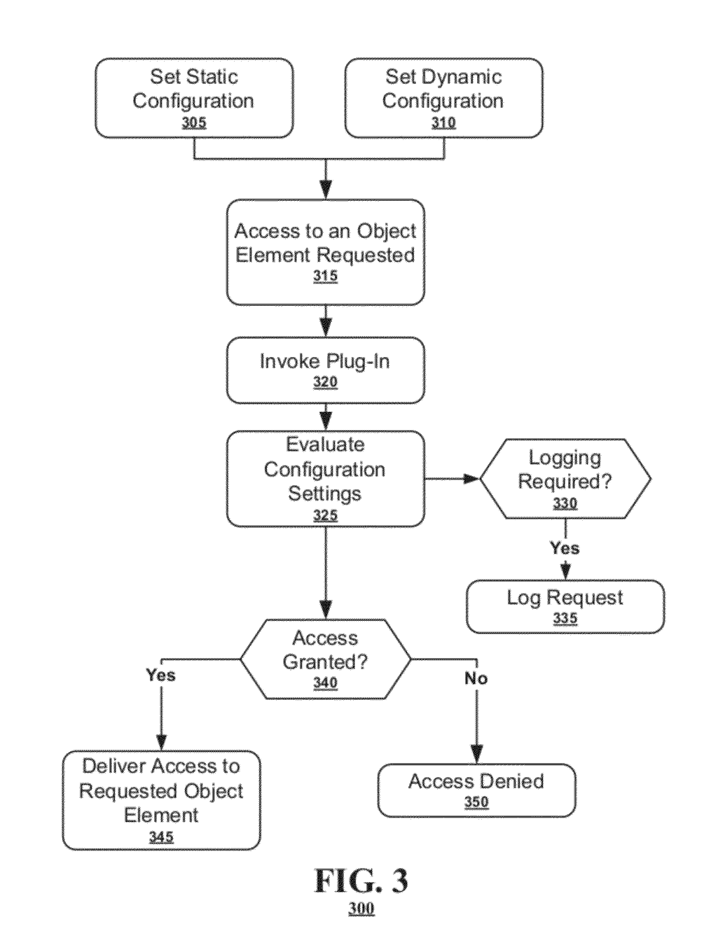

FIG. 3 illustrates an exemplary method 300 for a subject utilizing the access control framework (ACF) according to an embodiment of the present invention. A subject with access to the ACF may define the configuration settings of the ACF. The static configuration settings of the ACF may set system level access controls for a specified subject by role or object that may persist between sessions (block 305). The static configuration settings of the ACF may also be set to grant subjects access to the ACF, for example, by granting a subject temporary or permanent ACF consumer status. The dynamic configuration settings of the ACF may set temporary access permissions for a business object or element of a business object (block 310). The dynamic configuration settings may be defined by a subject having ACF consumer status.

After defining the configuration settings, the subject may request access to a business object or element (block 315). In some ACF systems, the subject may not have access to the configuration settings. Then the subject may request access to a business object or element without first defining the configuration settings. Then the method 300 may begin with the access request (block 315).

If the ACF is enabled for the requesting subject, the ACF plug-in may be invoked before access is granted or denied (block 320). The configuration settings may then be evaluated to determine the action to be taken responsive to the request (block 325). If the dynamic configuration includes an action corresponding to the requesting subject or the requested object, the action may be performed. If the dynamic configuration does not address the session permissions for the requesting subject or requested object, the static configuration may set forth an action corresponding the requesting subject or the requested object. The configuration settings may additionally set forth logging requirements (block 330). If logging is initiated, the request and corresponding action may be logged (block 335). The log may persist for the duration of the session or longer to facilitate a review of the log for testing or debugging purposes.

The configuration settings may also establish whether access to the requested object or element is to be granted or denied (block 340). If access is granted, the subject may then be given access to the object or element according to the requested action (block 345). For example, the request may comprise a read request for a business object, for an instance of a business object, or for a sales order. Then the requested object or element may be displayed to the subject. The request may comprise a write request for a business object or element in which case the subject may be presented with a business object or element to edit or may be able to create a new business object or element according to the requested action. Other actions may additionally be the focus of the request.

If access to the requested business object is denied, the method 300 may perform an alternate action according to the ACF settings (block 350). The configuration settings for the ACF may specify the logging of an access request that is not granted should be handled. For example, the violation may trigger logging of an assertion in a test log, or a break point in the processing may be activated, or both. Access requests may be automatically detected until the logs can be processed at the user interface, or may be stored in memory for a longer period of time for testing or review. Additionally, access may be allowed and a subject's request granted even where an access control policy violation occurred, thereby allowing the subject access to the requested object despite the access permissions for the object. Or a fatal exception may be raised that may terminate the session to ensure that unauthorized access is prevented. Any combination of these, or other available actions may be implemented to facilitate execution of a unit test, monitoring a runtime report, or attempting to debug an error in the system, for example.

The method 300 may be utilized to define a test element and service simulations by identifying the accessed business objects, elements and related services to implement more effective automated tests. When utilized as part of a unit test, specialized logging features may additionally trigger an assertion that may be recorded as part of the test log. Method 300 may be implemented to detect changed interaction patterns between objects and detect missed adaptations to compensate for the un-integrated patterns during application development. During partner development, the method 300 may be implemented to enforce proper access to objects, functionality, and information. Or the method 300 may be implemented to monitor or control user access to effectuate variable billing plans that may be based on object access. By tracking the object accesses, statistics about the usage of certain objects, elements or functions may be accumulated. Then a customer may be billed for actual usage.

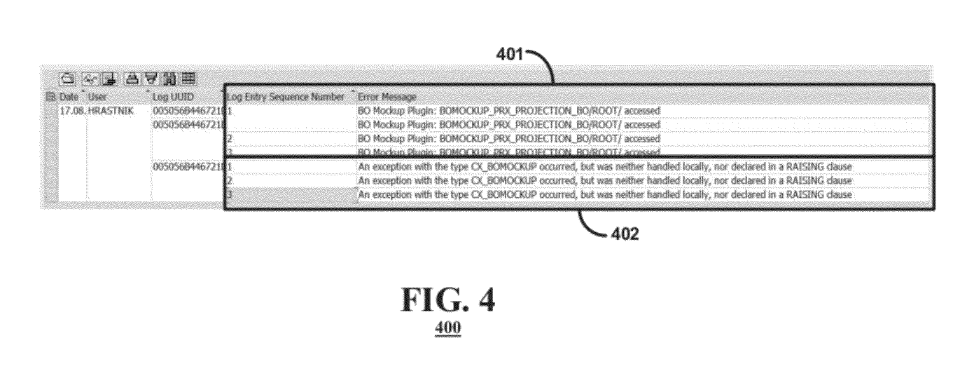

FIG. 4 shows an exemplary user interface according to an embodiment of the present invention. The cockpit user interface may provide information to the user in accordance with FIG. 4. As shown, the cockpit 400 may include logging information viewable by date, by user, by logging ID, by log sequence number, by error message, or by any other information collected in the course of logging access requests and detected violations. In accordance with an aspect of this invention, detected access violations 401 may be listed such that each record in the log may further indicate the object for which access was attempted. The error message information may also include additional information about problematic service provider behavior 402 or other detectable run time errors. The violations and errors may be displayed in the cockpit as unit tests are executed or to debug an error in the business center application.

The foregoing discussion identifies functional blocks that may be used in business information systems constructed according to various embodiments of the present invention. In practice, these systems may be applied in a variety of devices, such as personal computing systems, mobile devices, or network servers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, not all of the functional blocks described herein need be provided or need be provided as separate units. For example, although FIG. 2 illustrates the components of an exemplary computing system, such as the controller 220 and the log handler 240 as separate modules, in one or more embodiments, they may be integrated. Additionally, the plug-in 235 is shown as being called from the system manager 230. However, a similar plug-in may be activated from an alternate generic framework. Such implementation details are immaterial to the operation of the present invention unless otherwise noted above.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method for controlling access in a business information system comprising:
responsive to a request for access to an object element, determining whether an access permission is granted for the requested object element; and
if the access permission is granted, permitting access to the object element.

2. The method of claim 1 wherein the object element is selected from the group consisting of a business object, a business object node, an instance, an attribute, a business object query, an action, and an association.

3. The method of claim 1 further comprising setting an access permission for an object element.

4. The method of claim 3 wherein said setting further comprises setting object element access permissions for a subject.

5. The method of claim 3 wherein said setting further comprises setting a static configuration.

6. The method of claim 5 wherein said static configuration defines access permissions for editing a dynamic configuration.

7. The method of claim 3 wherein said setting further comprises setting a dynamic configuration.

8. The method of claim 7 wherein said dynamic configuration defines object element access permissions for a session.

9. The method of claim 1 wherein said determining further comprises querying a database for the access permission information corresponding to the object element.

10. The method of claim 1 further comprising logging the access request and response.

11. The method of claim 10 further comprising defining access permissions for the request logs.

12. The method of claim 1 further comprising, if the access permission is denied, permitting access to the object element.

13. The method of claim 1 further comprising, if the access permission is denied, raising a fatal exception.

14. A business information system implementing access control comprising:
a memory for storing a plurality of object elements, wherein each stored object element has an associated stored access permission; and
a controller configured to determine access to an object element according to the stored object element permissions;
wherein responsive to a request for access to the object element, if the access is granted, the controller permits access to the object element.

15. The system of claim 14 wherein the object element is selected from the group consisting of a business object, a business object node, an instance, an attribute, a business object query, an action, and an association.

16. The system of claim 14 wherein the controller permits a stored access permission for an object element to be edited.

17. The system of claim 14 wherein the stored access permissions for the plurality of object elements further comprise a static configuration.

18. The system of claim 17 wherein said static configuration defines access permissions for editing a dynamic configuration.

19. The system of claim 17 wherein said static configuration defines object element access permissions for a subject.

20. The system of claim 14 wherein the stored access permissions for the plurality of object elements further comprise a dynamic configuration.

21. The system of claim 20 wherein said dynamic configuration defines object element access permissions for a session.

22. The system of claim 14 further comprising a log handler to manage logging for the access request and response.

23. The system of claim 22 further comprising a memory for storing log data.

24. The system of claim 23 wherein the controller determines an access permission for the stored log data.
